(19) United States
(12) Patent Application Publication
(10) Pub. No.: US 2024/0280970 A1
(43) Pub. Date: Aug. 22, 2024

(54) CONTROLLER

(71) Applicant: OKUMA Corporation, Niwa-gun (JP)

(72) Inventors: Shunichi TAKASHIMA, Niwa-gun (JP); Takeshi SAKAI, Niwa-gun (JP)

(21) Appl. No.: 18/438,958

(22) Filed: Feb. 12, 2024

(30) Foreign Application Priority Data
Feb. 17, 2023 (JP) 2023-023490

(51) Int. Cl. G05B 19/416

(52) U.S. Cl. CPC G05B 19/4166; G05B 2219/49078

(57) ABSTRACT

A controller for a machine tool that moves a feed shaft moving a cutting tool and a workpiece to thereby cut the workpiece. The controller includes a command generator outputting a moving command to shift the feed shaft in a feeding direction while allowing the feed shaft to oscillate along the feeding direction, a position controller outputting a velocity command, a velocity controller outputting a torque command, a current controller controlling motor line current, and an inversion compensation calculator calculating a compensation amount compensating for a tracking delay caused by inversion of a moving direction of the feed shaft and adding the compensation amount to the moving command etc. for inversion compensation. The controller does not perform the inversion compensation unless the feeding direction is inverted, in spite of inversion of the moving direction of the feed shaft due to oscillation.

### CROSS REFERENCE TO RELATED APPLICATION

The present invention claims priority under 35 U.S.C. §119 to Japanese Patent Application No. 2023-023490 filed on Feb. 17, 2023, the entire content of which is incorporated herein by reference.

### TECHNICAL FIELD

The present disclosure relates to a controller for controlling the position of a feed shaft of a machine tool that performs oscillation cutting.

### BACKGROUND

Conventionally known machine tools include a main spindle for rotating a cutting tool and a cutting target or a workpiece relative to each other, and a feed shaft for moving the cutting tool and the workpiece relative to each other. The machine tool cuts the workpiece with the cutting tool while moving the feed shaft. During the cutting processing, elongated swarf or shavings may be generated and entangled with the workpiece or the cutting tool. This results in damage to the workpiece or failure of the machine tool. To address this disadvantage, there is proposed oscillation cutting, which is a cutting method for fragmenting swarf while oscillating the cutting tool and the workpiece relative to each other.

In performing oscillation cutting, a controller as illustrated in FIG. 7 is used. FIG. 7 is a block diagram illustrating a controller for a machine tool according to a conventional technique, and illustrates a known controller 1. The controller 1 is part of elements constituting a machine tool (not shown), and controls the position of a feed shaft of the machine tool. As illustrated in FIG. 7, the machine tool includes, in addition to the controller 1, a motor 2 that controls the main spindle and the feed shaft, a detector 3 attached to the motor 2, and a target plant 4 that moves according to driving of the motor 2. More specifically, the controller 1 drives the motor 2 to control the position of the target plant 4. The position of the target plant 4 is detected by the detector 3.

As illustrated in FIG. 7, the controller 1 includes a command generator 10, a feedback controller 20, and an inversion compensation calculator 31. The command generator 10, in response to an instruction for oscillation cutting, outputs a moving command to shift the feed shaft of the machine tool toward the feeding direction while oscillating the feed shaft in the feeding direction. The “feeding direction” as used herein refers to a direction in which the feed shaft is aimed at traveling. In the following description, the expression such as “to shift in the feeding direction” is used as appropriate. The feedback controller 20 includes a position controller 21, a velocity controller 22, and a current controller 23. The position controller 21, based on the moving command output from the command generator 10, outputs a velocity command. The velocity controller 22, based on the velocity command output from the position controller 21 and the rotation rate of the motor 2 obtained by differentiating position information of the feed shaft that is supplied from the detector 3, outputs a torque command. The current controller 23, based on the torque command output from the velocity controller 22 and an actual current value, supplies electric current to the motor 2 to drive the motor 2. As such, the command generator 10 outputs a moving command, and the feedback controller 20 performs position control, velocity control, and current control, to thereby drive the motor 2. The position and velocity of the motor 2 are detected by the detector 3 attached to the motor 2 and then supplied to the feedback controller 20 for controlling the motor 2. Here, inversion of the moving direction of the feed shaft according to the moving command output from the command generator 10 causes a tracking delay due to static friction or distortion of the driving system. To compensate for this tracking delay caused at the time of inversion, the inversion compensation calculator 31 is provided. Specifically, the inversion compensation calculator 31 calculates a compensation amount for compensating for the tracking delay caused at the time of inversion of the moving direction of the feed shaft. The inversion compensation calculator 31 then adds the compensation amount to at least one of the moving command output from the command generator 10, the velocity command output from the position controller 21, and the torque command output from the velocity controller 22, for inversion compensation. The “moving direction” as used herein refers to a direction of movement of the feed shaft, and includes an oscillating motion. Therefore, the feeding direction and the moving direction are not always the same.

If inversion compensation is to be performed at the time of inversion of the moving direction of the feed shaft due to oscillation during oscillation cutting, such inversion compensation would be performed for every half period of the oscillation period. This causes difficulties, including a reduction in the life time of the machine tool, generation of unusual noise from the feed shaft, and deterioration of surface roughness of the processing face of the workpiece. Embodiments of the present disclosure are therefore aimed toward providing a controller that addresses the above difficulties.

### SUMMARY

In accordance with an aspect of the disclosure, there is provided a controller for a machine tool having a feed shaft that moves a cutting tool and a workpiece relative to each other and configured to cut the workpiece with the cutting tool while moving the feed shaft. The controller is configured to function as a command generator configured to output, in response to an instruction for oscillation cutting, a moving command to shift the feed shaft toward a feeding direction while allowing the feed shaft to oscillate in the feeding direction, a position controller configured to output a velocity command based on the moving command; a velocity controller configured to output a torque command based on the velocity command; a current controller configured to control motor line current based on the torque command; and an inversion compensation calculator configured to calculate a compensation amount for compensating for a tracking delay caused by inversion of a moving direction of the feed shaft, and to add the compensation amount to at least one of the moving command, the velocity command, and the torque command for inversion compensation. The controller is configured not to perform the inversion compensation unless the feeding direction is inverted, in spite of inversion of the moving direction of the feed shaft due to oscillation.

The controller may be configured not to perform the inversion compensation when the oscillation cutting is instructed and to perform the inversion compensation when the oscillation cutting is not instructed.

The command generator may include a feed command generator configured to output a moving command to move the feed shaft in the feeding direction; and an oscillation command generator configured to output a moving command to allow the feed shaft to oscillate, and the controller may be configured to perform the inversion compensation based on the moving command output from the feed command generator independently of the moving command output from the oscillation command generator.

The command generator may include a feed command generator configured to output a moving command to move the feed shaft in the feeding direction; and an oscillation command generator configured to output a moving command to allow the feed shaft to oscillate. The inversion compensation calculator may be configured to calculate the compensation amount based on a combined command that is a combination of the moving command output from the feed command generator and the moving command output from the oscillation command generator. The controller may be configured to determine whether or not the feeding direction is inverted based on the moving command output from the feed command generator, and, upon determining that the feeding direction is inverted, to perform the inversion compensation.

The command generator may include a feed command generator configured to output a moving command to move the feed shaft in the feeding direction; and an oscillation command generator configured to output a moving command to allow the feed shaft to oscillate. The inversion compensation calculator may be configured to calculate the compensation amount based on a combined command that is a combination of the moving command output from the feed command generator and the moving command output from the oscillation command generator, and the controller may be configured to perform the inversion compensation, when, after the feed command generator outputs a moving command to invert the feeding direction, the feed shaft is inverted, based on the combined command, to a direction identical to the feeding direction.

The controller according to the disclosure does not perform inversion compensation unless the feeding direction is inverted, in response to an instruction for oscillation cutting, in spite of occurrence of inversion of the moving direction of the feed shaft caused by oscillation. This configuration eliminates unnecessary inversion compensation to thereby reduce a load on the machine tool or unusual noise generated at the feed shaft.

### BRIEF DESCRIPTION OF DRAWINGS

Embodiments of the present disclosure will be described based on the following figures, wherein:

FIG. 1 is a block diagram illustrating a first embodiment of the disclosure;

FIG. 2 is a block diagram illustrating a second embodiment of the disclosure;

FIG. 3 is a chart showing the position of a feed shaft for use in calculation of a compensation amount and the actual position of the feed shaft, at the time of output of a moving command for use in calculation of a compensation amount;

FIG. 4 is a block diagram illustrating a third embodiment of the disclosure;

FIG. 5 is a chart showing a difference between a time of output of a moving command from a feed command generator and a time of actual inversion of the feeding direction of the feed shaft;

FIG. 6 is a block diagram illustrating a fourth embodiment of the disclosure; and

FIG. 7 is a block diagram illustrating a conventional controller for a machine tool.

### DESCRIPTION OF EMBODIMENTS

Embodiments of the present disclosure will be described below by reference to the drawings, in which elements that are identical with those in related art illustrated in FIG. 7 are denoted with the same reference numerals and will not be further described. These embodiments are examples for showing various forms of the disclosure and do not limit functions of the disclosure.

The embodiments are disclosed in the specification based on the precondition that inversion compensation is performed under conditions that are different from those in the related art illustrated in FIG. 7. Specifically, the related art example is configured to perform inversion compensation in response to inversion of the moving direction of the feed shaft. As described above, the “moving direction” refers to the direction of movement of the feed shaft, and includes an oscillating motion. Therefore, inversion compensation is performed principally in response to inversion of the direction in which the feed shaft travels, regardless of whether the inversion is inversion of the moving direction of the feed shaft caused by oscillation or inversion of the feeding direction of the feed shaft. Meanwhile, according to the embodiments disclosed in the specification, inversion compensation is not performed unless the feeding direction is inverted, even if the moving direction of the feed shaft is inverted by oscillation. Each embodiment will be described based on this precondition.

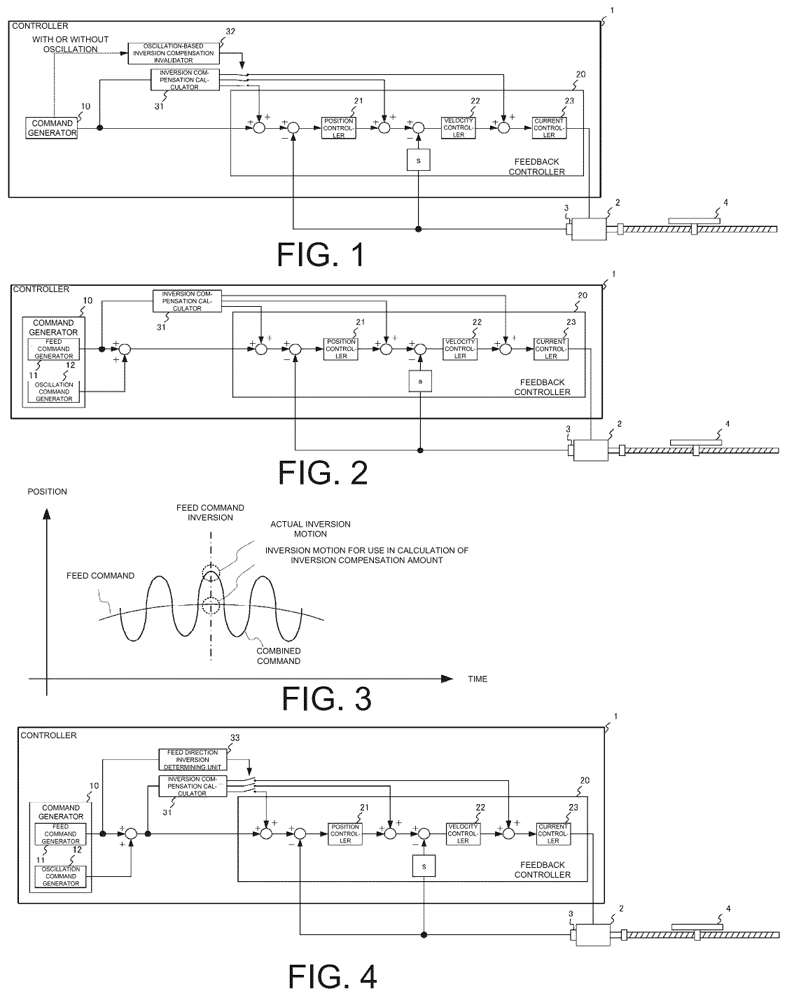

FIG. 1 is a block diagram of a controller 1 according to a first embodiment of the disclosure. As illustrated in FIG. 1, the controller 1 includes, in addition to the command generator 10, the feedback controller 20, and the inversion compensation calculator 31, an oscillation-based inversion compensation invalidator 32. The oscillation-based inversion compensation invalidator 32 determines whether or not oscillation cutting is instructed by a moving command output from the command generator 10. In response to an instruction for oscillation cutting, the oscillation-based inversion compensation invalidator 32 invalidates inversion compensation.

This configuration enables the oscillation-based inversion compensation invalidator 32 to invalidate inversion compensation, in response to an instruction to perform oscillation cutting, thereby preventing inversion compensation. This prevents exertion of an excessive inversion force during oscillation cutting, thereby reducing loads applied to the machine tool and unusual noises generated by the feed shaft. In the absence of an instruction for oscillation cutting, inversion compensation is performed. This configuration therefore achieves appropriate tracking performance based on inversion compensation.

However, the above configuration which invalidates inversion compensation during oscillation cutting cannot compensate for a tracking delay caused at the time of inversion of the feeding direction of the feed shaft, with an oscillation motion also being involved. FIG. 2 illustrates a controller for addressing this disadvantage.

FIG. 2 is a block diagram illustrating the controller 1 according to a second embodiment of the disclosure. As illustrated in FIG. 2, the command generator 10 further includes a feed command generator 11 and an oscillation command generator 12. The feed command generator 11 outputs a moving command for moving the feed shaft in the feeding direction. The oscillation command generator 12 outputs a moving command to allow the feed shaft to oscillate. In this embodiment, inversion compensation is performed based on the moving command output from the feed command generator 11. In other words, inversion compensation is performed independently of the moving command from the oscillation command generator 12. Therefore, inversion compensation is not performed unless the feeding direction of the feed shaft is inverted, while an oscillation motion is involved. Meanwhile, inversion compensation is performed in response to inversion of the feeding direction of the feed shaft with an oscillation motion being included, which addresses the above disadvantage which remains unresolved in the first embodiment.

During oscillation cutting, the feed shaft moves based on a combined command that is a combination of a moving command output from the feed command generator 11 and a moving command output from the oscillation command generator 12. However, inversion compensation is performed independently of the moving command from the oscillation command generator 12 as described above, which leads to another disadvantage that will be described by reference to FIG. 3. FIG. 3 shows the position of the feed shaft for use in calculation of a compensation amount and the actual position of the feed shaft, at the time of output of a moving command for use in calculation of a compensation amount. When the feed command generator 11 outputs a moving command to invert the feeding direction, this moving command from the feed command generator 11 is used to calculate the amount of compensation for inversion. FIG. 3 indicates the position of the feed shaft specified by the moving command for use in calculation of the compensation amount with a dashed line circle where the curved line of the feed command intersects the time axis of inversion based on the feed command, which differs from the actual position where the feeding direction of the feed shaft is inverted. FIG. 3 indicates the actual position of inversion of the feeding direction with a dashed line circle where the curved line of a combined command intersects the time axis of inversion based on a feed command. As illustrated in FIG. 3, the inversion motion for use in calculation of the compensation amount and the actual inversion motion based on the combined command differ from each other. Therefore, the inversion compensation performed based on the moving command output from the feed command generator 11; that is, the inversion compensation performed independently of the moving command output from the oscillation command generator 12, may fail to achieve appropriate compensation. A controller for addressing this disadvantage is illustrated in FIG. 4.

FIG. 4 is a block diagram illustrating the controller 1 according to a third embodiment of the disclosure. The controller 1 illustrated in FIG. 4 further includes a feed direction inversion determining unit 33. The feed direction inversion determining unit 33 determines whether or not the feeding direction has been inverted based on the moving command output from the feed command generator 11. Further, as illustrated in FIG. 4, the inversion compensation calculator 31 calculates the compensation amount based on the combined command that is a combination of a moving command output from the feed command generator 11 and a moving command output from the oscillation command generator 12. In this embodiment, only in response to the determination that the feeding direction has been inverted based on the moving command output from the feed command generator 11 made by the feed direction inversion determining unit 33, the compensation amount calculated by the inversion compensation calculator 31 is supplied to the feedback controller 20. Thus, in response to the moving command to invert the feeding direction output from the feed command generator 11, inversion compensation according to the actual inversion motion is performed.

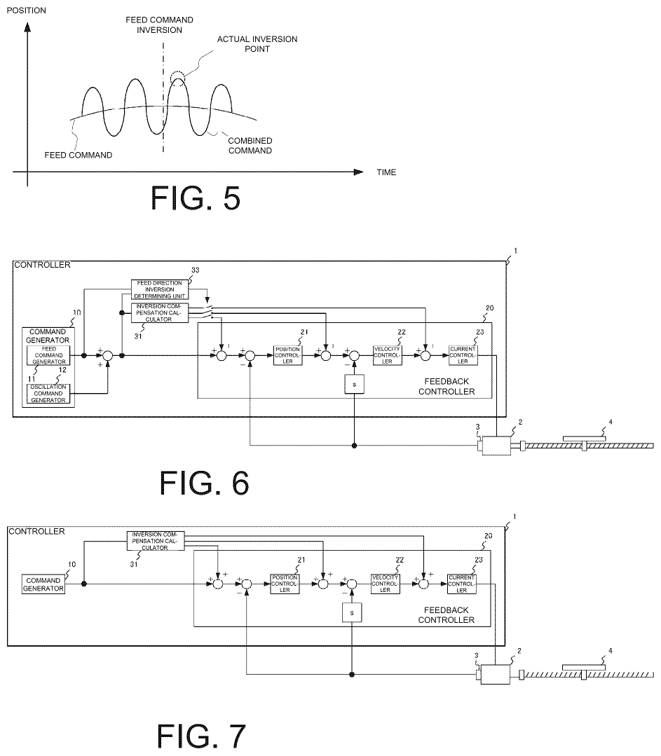

According to the above configuration, inversion compensation is performed on the precondition that the time of inversion of the feeding direction based on the moving command output from the feed command generator 11 and the time of inversion of the feeding direction based on the combined command match. However, these two inversion times do not always match. FIG. 5 shows an example in which, after the feed command generator 11 outputs a moving command, the feeding direction is inverted, based on a combined command, to a direction identical with the feeding direction instructed by the moving command. FIG. 5 shows a difference between the time at which the feed command generator 11 outputs a moving command and the time of actual inversion of the feeding direction of the feed shaft. When the above two inversion times do not match as illustrated in FIG. 5, inversion compensation according to the method in the third embodiment would not achieve appropriate compensation. Specifically, the inversion compensation is not performed at the actual time of inversion of the feeding direction of the feed shaft, and therefore appropriate tracking performance based on inversion compensation cannot be achieved. FIG. 6 illustrates a controller that addresses this disadvantage.

FIG. 6 is a block diagram illustrating the controller 1 according to a fourth embodiment of the present. The controller 1 illustrated in FIG. 6 is configured to perform inversion compensation in response to inversion of the feeding shaft based on a combined command, after the feed command generator 11 outputs a moving command to invert the feeding direction, to the same direction as the feeding direction. More specifically, when, after the feeding direction is inverted, the moving direction of the feed shaft is also inverted to the same direction as the inverted feeding direction, inversion compensation is executed. This enables inversion compensation simultaneously with the actual time of inversion of the moving direction of the feed shaft.

As described above, the controller according to the disclosure does not perform inversion compensation unless the feeding direction of the feed shaft is inverted, even if the moving direction of the feed shaft is inverted due to oscillation. This results in reduction in the load on the machine tool or unusual noise generated at the feed shaft. The above configuration further enables inversion compensation to be performed in synchronism with the time of actual inversion of the moving direction of the feed shaft, thereby addressing the disadvantages in conventional controllers while maintaining machining precision equivalent to that of machining without oscillation cutting process. In the disclosure, the command generator 10, the feedback controller 20, the inversion compensation calculator 31, the oscillation-based inversion compensation invalidator 32, and the feed direction inversion determining unit 33 are physically configured by a processor, and the controller 1 is implemented by one or more units including the processor. Further, the detector 3 is configured to detect an amount of condition of the motor and may be an angle detector or a position detector, for example.

### Reference Sign List

1 controller, 2 motor, 3 detector, 4 target plant, 10 command generator, 11 feed command generator, 12 oscillation command generator, 20 feedback controller, 21 position controller, 22 velocity controller, 23 current controller, 31 inversion compensation calculator, 32 oscillation-based inversion compensation invalidator, 33 feed direction inversion determining unit.

1. A controller for a machine tool having a feed shaft that moves a cutting tool and a workpiece relative to each other, the machine tool configured to cut the workpiece with the cutting tool while moving the feed shaft,
wherein the controller is configured to function as:
a command generator configured to output, in response to an instruction for oscillation cutting, a moving command to shift the feed shaft toward a feeding direction while allowing the feed shaft to oscillate in the feeding direction,
a position controller configured to output a velocity command based on the moving command;
a velocity controller configured to output a torque command based on the velocity command;
a current controller configured to control motor line current based on the torque command; and
an inversion compensation calculator configured to calculate a compensation amount for compensating for a tracking delay caused by inversion of a moving direction of the feed shaft, and to add the compensation amount to at least one of the moving command, the velocity command, and the torque command for inversion compensation,
wherein the controller is configured not to perform the inversion compensation unless the feeding direction is inverted, in spite of inversion of the moving direction of the feed shaft due to oscillation.

2. The controller according to claim 1, wherein
the controller is configured not to perform the inversion compensation when the oscillation cutting is instructed and to perform the inversion compensation when the oscillation cutting is not instructed.

3. The controller according to claim 1, wherein
the command generator includes:
a feed command generator configured to output a moving command to move the feed shaft in the feeding direction; and
an oscillation command generator configured to output a moving command to allow the feed shaft to oscillate, and
the controller is configured to perform the inversion compensation based on the moving command output from the feed command generator independently of the moving command output from the oscillation command generator.

4. The controller according to claim 1, wherein
the command generator includes:
a feed command generator configured to output a moving command to move the feed shaft in the feeding direction; and
an oscillation command generator configured to output a moving command to allow the feed shaft to oscillate,
the inversion compensation calculator is configured to calculate the compensation amount based on a combined command that is a combination of the moving command output from the feed command generator and the moving command output from the oscillation command generator, and
the controller is configured to determine whether or not the feeding direction is inverted based on the moving command output from the feed command generator, and, upon determining that the feeding direction is inverted, to perform the inversion compensation.

5. The controller according to claim 1, wherein
the command generator includes:
a feed command generator configured to output a moving command to move the feed shaft in the feeding direction; and
an oscillation command generator configured to output a moving command to allow the feed shaft to oscillate,
the inversion compensation calculator is configured to calculate the compensation amount based on a combined command that is a combination of the moving command output from the feed command generator and the moving command output from the oscillation command generator, and
the controller is configured to perform the inversion compensation, when, after the feed command generator outputs a moving command to invert the feeding direction, the feed shaft is inverted, based on the combined command, to a direction identical to the feeding direction.
